(19) United States
(12) Patent Application Publication
(10) Pub. No.: US 2014/0226523 A1
(43) Pub. Date: Aug. 14, 2014

(54) MECHANISM TO DYNAMICALLY APPLY CONFIGURATION SETTINGS TO INTERFACES USING A PORT-PROFILE

(71) Applicant: CISCO TECHNOLOGY, INC., San Jose, CA (US)

(72) Inventor: Sushrut Sudhakar Deshpande, Bangalore (IN)

(73) Assignee: CISCO TECHNOLOGY, INC., San Jose, CA (US)

(21) Appl. No.: 13/767,004

(22) Filed: Feb. 14, 2013

(51) Int. Cl. H04L 12/931; H04L 12/24

(52) U.S. Cl. CPC H04L 49/70; H04L 41/0806
USPC 370/254

(57) ABSTRACT

A system and method for dynamically applying configuration settings to an interface associated with a port-profile. A script may be defined within the port-profile to configure the interface. In some implementations, a configuration may be dynamically applied to configure to an interface having a same port-profile to as multiple interfaces. A port group may be assigned to the interface, where the port group is defined by the port-profile, the port-profile defining a common set of configuration policies for the multiple interfaces. The port-profile is applied to each interface of the multiple interfaces as each interface comes online. A script inside the port-profile is specified to define aspects of the interface and executed to further configure the interface in accordance with an association of the interface with, e.g., a virtual machine.

### BACKGROUND

Data centers often use a small percentage of available CPU, storage, and memory capacity, which often results in the deployment of more servers than are necessary to perform a specified amount of work. Additional servers increase costs and create a more complex environment that can be difficult to manage. As such, many data center managers are turning to virtualization so that resources can be shared across a network.

Virtualization is a technology which allows one computer to do the job of multiple computers by sharing resources of a single computer across multiple systems. Through the use of virtualization, multiple operating systems and applications can run on the same computer at the same time, thereby increasing utilization and flexibility of hardware. Virtualization allows servers to be decoupled from underlying hardware, thus resulting in multiple virtual servers sharing the same physical server hardware. This also allows the virtual server to be moved from one physical server to another physical server while maintaining continuous service availability.

On some virtualization platforms, a port-profile is used to apply common set of configurations to a set of interfaces. For example, in the virtualization or cloud environment, port-profiles are applied to multiple interfaces. There are situations where these port-profiles are dynamically created and applied to all of the interfaces connected to, e.g., Virtual Machines (VMs). This makes it difficult to have different configuration settings that are applied to interfaces in same the port-profile, but that are connected to different types of Virtual Machines (e.g., service VMs, normal VMs). In a similar situation, there may be different security and Quality of Service (QOS) policies for different VMs in same port-profile. In general, it is cumbersome to have to create different port-profiles for each of the different types VMs where the VMs have different combination of specific configurations. It is similarly cumbersome to apply specific configurations under the interface manually.

### SUMMARY

A system and method for dynamically applying configuration settings to an interface associated with a port-profile. A script may be defined within the port-profile to configure the interface. In some implementations, there is provided a method for dynamically applying a configuration to an interface having a same port-profile to as multiple interfaces. The method may include assigning a port group to the interface; defining the port group by the port-profile, the port-profile defining a common set of configuration policies for the multiple interfaces; applying the port-profile to each interface of the multiple interfaces as each interface comes online; specifying a script inside the port-profile to define aspects of the interface; and executing the script to configure the interface.

In some implementations, there is provided an apparatus for dynamically applying a configuration to an interface within a same port-profile assigned to multiple interfaces. The apparatus may include a physical switch in communication with a plurality of network devices and a physical host comprising a virtual switch and at least one virtual machine. A port group may be assigned to the interface. A script may be specified inside the port-profile to define aspects of the interface, and wherein the script is executed to configure the interface.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

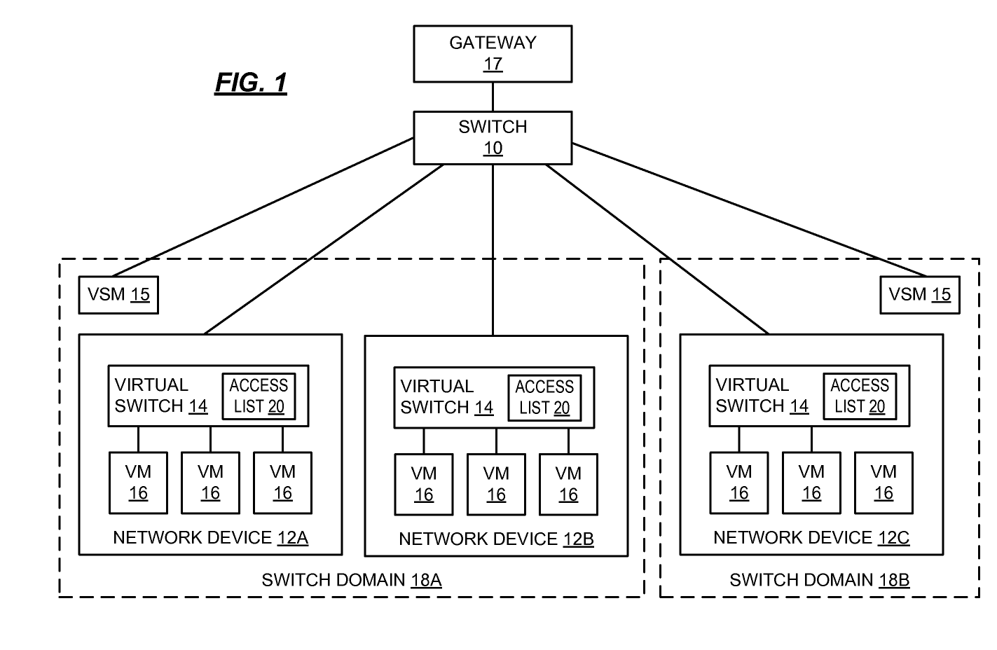

FIG. 1 illustrates an example of a network in which aspects described herein may be implemented;

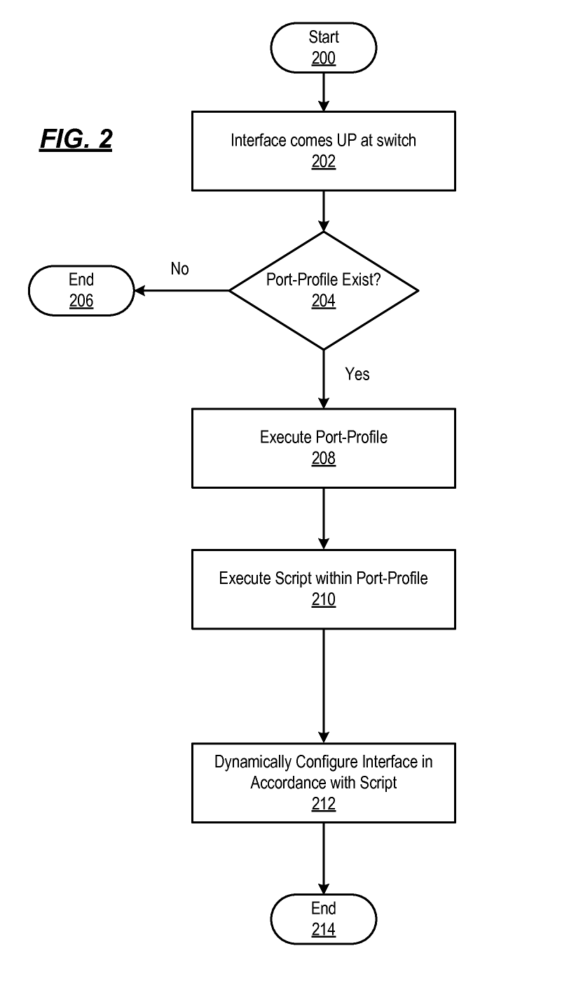

FIG. 2 is a flowchart illustrating an overview of a process to dynamically apply configuration settings using a script within a port-profile; and

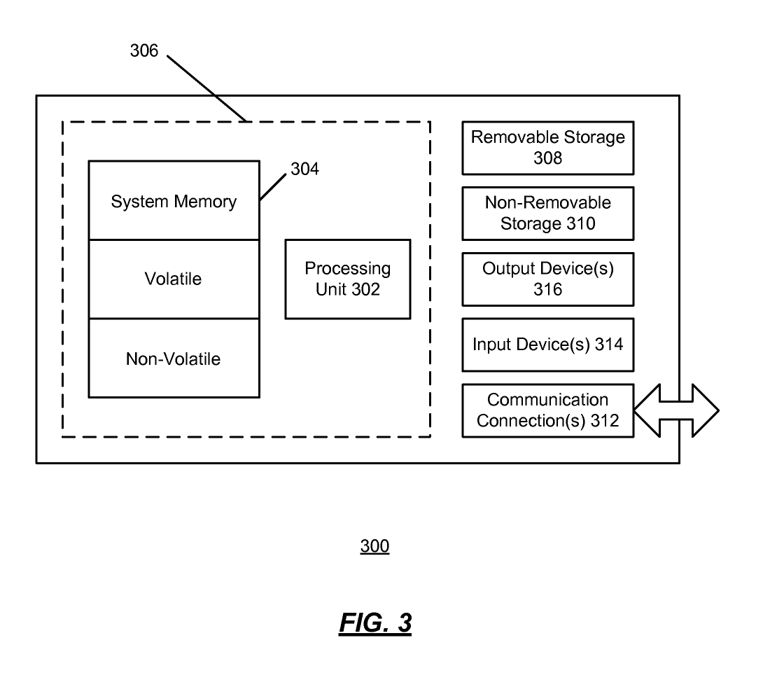

FIG. 3 is a block diagram of an example computer system that can be used to implement the systems and methods described herein.

### DETAILED DESCRIPTION

The following description is presented to enable one of ordinary skill in the art to make and use the implementations described herein. Descriptions of specific implementations and applications are provided only as examples, and various modifications will be readily apparent to those skilled in the art. The general principles described herein may be applied to other applications without departing from the scope of the present disclosure. Thus, the implementations are not to be limited to those shown, but are to be accorded the widest scope consistent with the principles and features described herein. For purpose of clarity, details relating to technical material that is known in the technical fields related to the implementations have not been described in detail.

Referring now to FIG. 1, there is provided an example of a network in which implementations described herein may be implemented is shown. The network may be configured for use as a data center or any other type of network. For simplification, only a small number of nodes are shown. The network includes a physical switch 10 in communication with a plurality of network devices (e.g., servers, hosts, physical machines) 12A, 12B, 12C, each comprising a virtual switch 14 and virtual machines (VMs) 16. The virtual machines 16 share hardware resources without interfering with each other so that several operating systems and applications can run at the same time on a single computer. The virtual machines 16 may be used, for example, in a virtual infrastructure to dynamically map physical resources to business needs. The virtual switches 14 operate to switch traffic between virtual machines 16.

The physical switch 10 is also in communication with a gateway 17, which may be in communication with any number of network devices or networks (not shown). The switch 10 may also be in communication with other network devices (e.g., switches, servers (e.g., DHCP (Dynamic Host Configuration Protocol) server), management station, router, gateway, etc.).

A virtual machine monitor such as hypervisor (not shown) dynamically allocates hardware resources to the virtual machines 16. The virtual machines 16 may be moved between servers, across layer 2 or layer 3 boundaries, based on traffic patterns, hardware resources, or other criteria.

In some implementations, the virtual switches 14 are part of a distributed virtual switch and reside in the physical hosts hosting the virtual machines 16. The distributed virtual switch includes a virtual switch component installed at the servers and a Virtual Supervisor Module (VSM) 15. The VSM 15 may be located in a physical appliance in communication with the servers via physical switch 10, or the VSM may be a virtual appliance (e.g., another virtual machine 16) installed at one of the servers in the network. The VSM 15 is configured to provide control plane functionality for the virtual machines 16. The virtual switch 14 provides switching capability at the server and operates as a data plane associated with the control plane of the VSM 15. The VSM 15 and virtual switch (VEM) 14 operate together to form a distributed virtual switch as viewed by a management station.

In the example shown in FIG. 1, two virtual switches 14 and a VSM 15 are located in a first switch domain (switch instance) 18A and one virtual switch and VSM are located in another virtual switch domain 18B. There may be any number of virtual switch domains 18 in communication with physical switch 10 or another switch in communication with gateway 17. In some implementations, each switch domain 18A, 18B comprises at least one VSM 15 and any number of virtual switches 14. The servers 12A, 12B, 12C may include any number of virtual machines 16.

Each virtual 14 switch may include a private virtual local area network access list 20 which is used to ensure that private VLANs configured on a switch are restricted to that particular switch. The private VLAN access list 20 may be implemented in software or hardware, and may use various algorithms. The private VLAN access list 20 may include, for example, MAC addresses, IPv4 or IPv6 addresses, or any other identifier. The private VLAN access list 20 described herein is only an example and it is contemplated that any construct may be used to maintain a list of identifiers that received packets can be checked against. The private VLAN access list 20 may be stored in memory allocated for virtual switch 14 at the server 12A, 12B, 12C or may be stored at the VSM 15, for example. The private VLAN access list 20 is preferably automatically generated and maintained and therefore does not need to be displayed to the user.

A MAC address is associated with each interface through means such as port security or static knowledge obtained from the underlying hypervisor. The virtual machine 16 may have more than one MAC address associated therewith, as permitted by user configuration for port security, for example. The distributed virtual switch uses this information to create the private VLAN access list 20 to associate the MAC addresses with ports using the same private VLAN configuration within that switch domain 18.

It is to be understood that the network shown in FIG. 1 and described herein is only one example and that the embodiments described herein may be implemented in networks having different network topologies and network devices, without departing from the scope of the embodiments. For example, different virtual switch configurations may be used or a physical switch may be used rather than a switch domain.

Referring again to FIG. 1, the virtual machines 16 are in communication with the virtual switch 14 via virtual network interface cards (VNICs) which connect to a virtual Ethernet interface at the virtual switch 14. The server 12A, 12B, 12C includes an Ethernet port for each physical network interface card. The Ethernet ports may be aggregated at a port channel. The virtual switches 14 are in communication with the network via the physical Ethernet interfaces. The virtual switch 14 switches traffic between the virtual machines 16 and the physical network interface cards.

A network administrator may assign a port group to the virtual network interface card. The port group may be defined by a port-profile, which is used to define a common set of configuration policies (attributes) for multiple interfaces. The port-profiles are associated with port configuration policies defined by the network administrator and applied automatically to a large number of ports as they come online in a virtual environment. For example, the port-profiles may be used to associate the private VLAN access list 20 with one or more ports, configure a VLAN, set Quality of Service (QoS) settings, etc.

When a new virtual machine 16 is created and assigned to the same port-profile or when existing virtual machines use additional MAC addresses, the private VLAN access list 20 is automatically modified thereby allowing the virtual machines on a community VLAN to communicate with one another while still restricting traffic that could be broadcast to the other switch from reaching the virtual machines belonging to, e.g., a different customer.

In some implementations, a customer or administrator may specify a user-defined script inside the port-profile to define aspects about the virtual machines 16. The script may be a TCL (Tool Command Language) script, which is an open source programming language suitable for, networking, administration, testing and other applications. The script may determine the context of a particular virtual machine 16 from, e.g. a vCenter (VC) server available from Cisco Technologies, Inc. (not shown). Based on the received context, the script may dynamically apply configuration settings to an interface(s) associated with the virtual machine 16. A library of scripts may be maintained.

In a non-limiting example, the script may issue a “showvm” command to the VC to determine the attributes of the virtual machine 16. For example, the virtual machine name or other information may be extracted. Logic may be built into the script to make decisions as to the configuration settings that should be applied to the virtual machine 16 based on the retrieved information. This script may be executed on each interface when it comes up and/or after all other configurations in the port-profile are executed.

In an implementation, with reference to FIG. 2, the script may perform the following exemplary sequence of operations that begins at 200. At 202, the interface to be configured comes up in a switch. For example, one of the interfaces in the virtual switch 14 associated with a, e.g., virtual machine 16, comes UP within a virtual environment. At 204, it is determined if a port-profile exists for the interface that came UP at 202. If no port-profile exists, then at 206, the sequence ends. For example in this scenario, interface may need to be manually configured by the administrator.

However, if a port-profile exists, at 208, the port-profile is executed. At 210, the script within the port-profile is executed. At 212, the interface is dynamically configured in accordance with the script to perform further configuration of the interface in accordance with the logic program within script. For example, the script will receive the port-profile name, interface number or other criteria as its argument. The script will make decisions to execute specific commands based on established attributes on the interface and/or based on “show command” outputs. Some implementations of TCL may utilize inbuilt libraries, and APIs to execute CLI commands within the script. Optionally, there may be specific attributes of the interface exposed on TCL libraries. Such features provides flexibility to have different configuration settings for different interfaces. At 214, the operations end when the TCL script has completed.

In accordance with the above, an example script may be as follows. The example script configures a port as trusted if the port is associated with a virtual machine 16 that has “dhcp” in the virtual machine name.

### getting the port-profile name and veth id from
argument and saving them under a variable #####
set port_profile_name [lindex $argv 0]
set vethid [lindex $argv 1]
set vmname “”
### Extracting virtual machine name for the Vethid for
which the Script is running ####
cli “terminal length 0”
set temp [ cli “show vtracker vm-view vnic” ]
foreach line [split $temp “\n”]
{

if { [regexp $vethid $line] }

{

set vmname [lindex $line 1]

}

}
##### If the VM name has “dhcp” in its name then it's
a dhcp server so need to make that port trusted ######
if { [regexp $vmname dhcp]}
{ cli “int veth $vethid ; ip dhcp snooping trust”}

Thus, the present disclosure provides a mechanism to dynamically apply different combinations of predetermined configurations to each interface inside the same port-profile.

FIG. 3 shows an exemplary computing environment in which example embodiments and aspects may be implemented. The computing system environment is only one example of a suitable computing environment and is not intended to suggest any limitation as to the scope of use or functionality.

With reference to FIG. 3, an exemplary system for implementing aspects described herein includes a computing device, such as computing device 300. In its most basic configuration, computing device 300 typically includes at least one processing unit 302 and memory 304. Depending on the exact configuration and type of computing device, memory 304 may be volatile (such as random access memory (RAM)), non-volatile (such as read-only memory (ROM), flash memory, etc.), or some combination of the two. This most basic configuration is illustrated in FIG. 3 by dashed line 306.

Computing device 300 may have additional features/functionality. For example, computing device 300 may include additional storage (removable and/or non-removable) including, but not limited to, magnetic or optical disks or tape. Such additional storage is illustrated in FIG. 3 by removable storage 308 and non-removable storage 310.

Computing device 300 typically includes a variety of tangible computer readable media. Tangible computer readable media can be any available media that can be accessed by device 300 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 304, removable storage 308, and non-removable storage 310 are all examples of tangible computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 300. Any such computer storage media may be part of computing device 300.

Computing device 300 may contain communications connection(s) 312 that allow the device to communicate with other devices. Computing device 300 may also have input device(s) 314 such as a keyboard, mouse, pen, voice input device, touch input device, etc. Output device(s) 316 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for dynamically applying a configuration to an interface having a same port-profile to as multiple interfaces, comprising:
assigning a port group to the interface;
defining the port group by the port-profile, the port-profile defining a common set of configuration policies for the multiple interfaces;
applying the port-profile to each interface of the multiple interfaces as each interface comes online;
specifying a script inside the port-profile to define aspects of the interface; and
executing the script to configure the interface.

2. The method of claim 1, wherein the port-profile is adapted to perform one of associating the private VLAN access list with one or more ports, configuring a VLAN, setting quality of service (QoS) settings and configuring a MAC address to each interface.

3. The method of claim 2, further comprising executing the script after the port-profile configures the interface.

4. The method of claim 1, wherein the script is specified as a user-defined Tool Command Language (TCL) script inside the port-profile to define aspects of the interface.

5. The method of claim 1, further comprising:
determining a context of a virtual machine associated with the interface; and
applying configuration settings to the interface in accordance with the context.

6. The method of claim 5, wherein the context is retrieved from a server that stores information about virtual machines.

7. The method of claim 5, wherein the context is determined in accordance with a virtual machine name.

8. An apparatus for dynamically applying a configuration to an interface within a same port-profile assigned to multiple interfaces, comprising:
a physical switch in communication with a plurality of network devices; and
a physical host comprising a virtual switch and at least one virtual machine,
wherein a port group is assigned to the interface, and wherein a script is specified inside the port-profile to define aspects of the interface, and wherein the script is executed to configure the interface.

9. The apparatus of claim 8, wherein the port-profile is dynamically created.

10. The apparatus of claim 9, wherein the port-profile is adapted to perform one of associating the private VLAN access list with one or more ports, configuring a VLAN, setting quality of service (QoS) settings and configuring a MAC address to each interface.

11. The apparatus of claim 11, wherein the script is executed after the port-profile configures the interface.

12. The apparatus of claim 9, wherein the script is specified as a user-defined Tool Command Language (TCL) script inside the port-profile to define aspects of the interface.

13. The apparatus of claim 9, wherein a context of a virtual machine associated with the interface is determined, and wherein configuration settings are applied to the interface in accordance with the context.

14. The apparatus of claim 13, wherein the context is retrieved from a server that stores information about virtual machines.

15. The apparatus of claim 13, wherein the context is determined in accordance with a virtual machine name.

16. A tangible computer readable medium having computer executable instructions stored thereon that when executed by a computing device perform a method, comprising:
assigning a port group to an interface;
defining the port group by a port-profile, the port-profile defining a common set of configuration policies for multiple interfaces;
applying the port-profile to each interface of the multiple interfaces as each interface comes online;
specify a script inside the port-profile to define aspects of the interface; and
executing the script to configure the interface.

17. The tangible computer readable medium of claim 16, wherein the script is specified as a user-defined Tool Command Language (TCL) script inside the port-profile to define aspects of the interface.

18. The tangible computer readable medium of claim 16, further comprising instructions for:
determining a context of a virtual machine associated with the interface; and
applying configuration settings to the interface in accordance with the context.

19. The tangible computer readable medium of claim 18, wherein the context is retrieved from a server that stores information about virtual machines.

20. The tangible computer readable medium of claim 18, wherein the context is determined in accordance with a virtual machine name.
